(19) United States
(12) Patent Application Publication
(10) Pub. No.: US 2012/0237919 A1
(43) Pub. Date: Sep. 20, 2012

(54) INTERACTIVE METHOD AND APPARATUS FOR PROVIDING INSTRUCTION

(76) Inventor: Sandra Kelly, Newton, IA (US)

(21) Appl. No.: 13/418,550

(22) Filed: Mar. 13, 2012

Related U.S. Application Data
(60) Provisional application No. 61/452,746, filed on Mar. 15, 2011.

(51) Int. Cl. G09B 7/00

(52) U.S. Cl. 434/362

(57) ABSTRACT

An interactive device and method for providing instruction. The interactive device and method includes providing an electronic device having a display screen and a plurality of keys. The plurality of keys include one or more program initiation buttons. A plurality of interactive educational programs are assigned to each of the one or more program initiation buttons. Actuation of one of the one or more program initiation buttons initiates and displays one of the plurality of interactive educational programs assigned to the actuated program initiation button on the display screen of the device.

### CROSS REFERENCE TO RELATED APPLICATION

This application claims the benefit of U.S. Provisional Application No. 61/452,746 filed Mar. 15, 2011.

### BACKGROUND OF THE INVENTION

This invention is directed toward an interactive system and method for providing instruction. More specifically, and without limitation, this invention relates to an interactive game provided on an electronic device for providing instruction as to how to live a healthy lifestyle and teaching children proper hygiene.

Proper hygiene is an important yet often overlooked component of maintaining a healthy lifestyle. Although most do not put much thought into simple, everyday activities such as hand washing or tooth brushing, learning how to properly take care of one's body is one of the most important skills a person can acquire. Furthermore, learning the proper methods and developing healthy habits of personal hygiene is essential for young children. Doing so not only has a beneficial impact on the health and development of children, but also carries over into adulthood and provides lasting benefits such as avoiding adverse health consequences and costs associated with poor hygiene, avoiding illness and the spread of germs to themselves and others, and promoting an overall well being in terms of self-confidence and social interactions.

Although young children are provided with personal hygiene instruction through books, various programs, and the like by parents, day-care personnel and/or school teachers, current methods of teaching hygiene to children suffer from drawbacks and thus improvements can be made. Namely, while various books and instructions can be provided to young children by parents, teachers, and/or instructors in a setting outside of the bathroom, young children may be unable to remember or unwilling to practice the steps of proper hygiene when, for example, the time comes for the child to actually wash their hands or brush their teeth.

Furthermore, even if an adult takes the time to provide instruction as the child is performing hygienic activities, the child still may be unable to perform the proper steps independently. Specifically, once again, the small child may be unable to remember or unwilling to perform proper hygiene activities without the assistance and/or supervision of an adult. Finally, while many books and teaching materials exist, such materials present the same information in a repetitive and non-interactive manner and require the assistance of an adult and are not designed to be provided while the child independently engages in the hygienic activities. Therefore there exists a need in the art that addresses these problems.

Therefore a primary object of this invention is to provide an interactive system and method for providing instruction that teaches children proper hygiene in a new and fun way.

It is yet another object of this invention to provide an interactive system and method for providing instruction as a game on an electronic device that children can play while engaging in and performing hygienic activities.

It is a further object of this invention to provide an interactive system and method for providing instruction as a game on an electronic device which provides the proper steps of brushing their teeth and washing their hands depending what button on the device is pressed.

These and other objects, features or advantages of the present invention will become apparent from the specification and claims.

### SUMMARY OF THE INVENTION

An interactive device and method for providing instruction include providing an electronic device having a display screen and a plurality of keys. The plurality of keys include one or more program initiation buttons. A plurality of interactive educational programs are assigned to each of the one or more program initiation buttons. Actuation of one of the one or more program initiation buttons initiates and displays one of the plurality of interactive educational programs assigned to the actuated program initiation button on the display screen of the device.

### BRIEF DESCRIPTION OF THE DRAWINGS

FIG. 1 is a plan view of the present interactive system and method for providing instruction;

FIG. 2 is a top view of the present interactive system and method for providing instruction;

FIG. 3 is a first side view of the present interactive system and method for providing instruction;

FIG. 4 is a second side view of the present interactive system and method for providing instruction; and

FIG. 5 is a schematic diagram of the present interactive system and method for providing instruction.

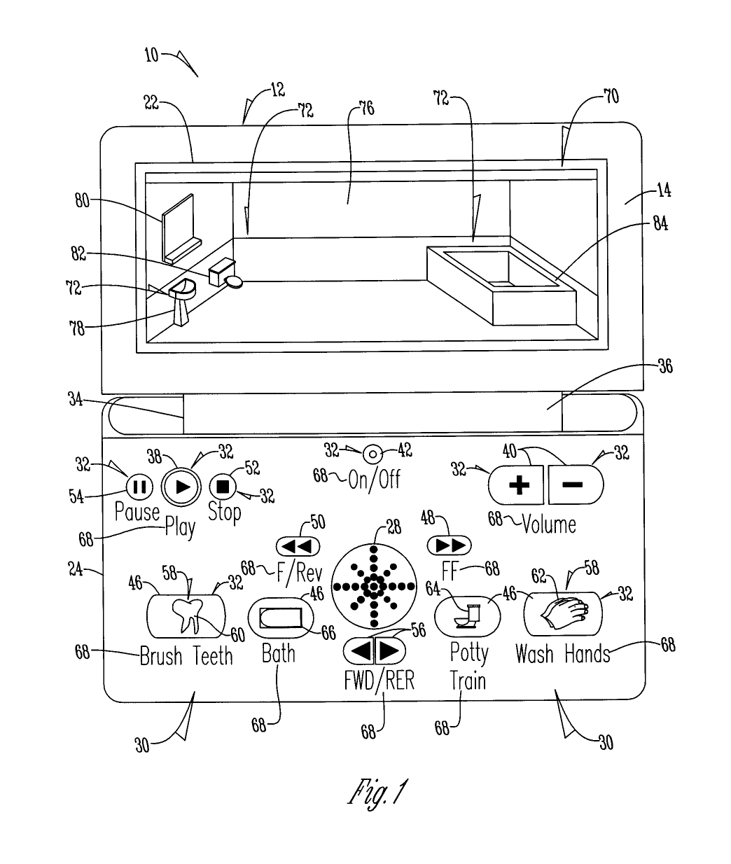

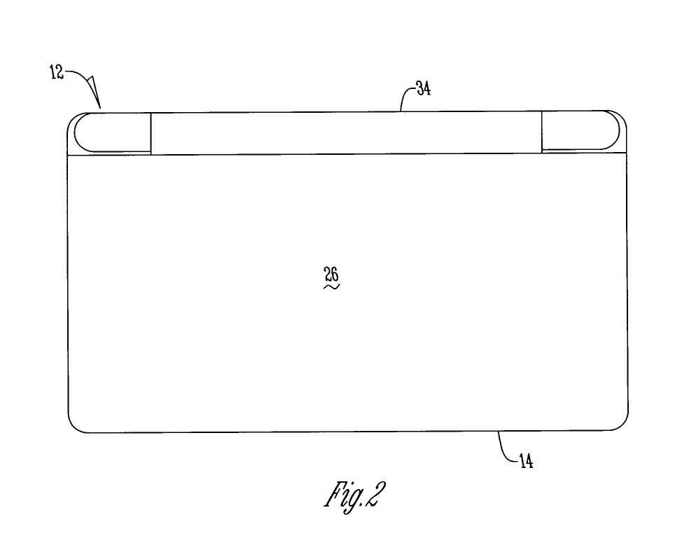

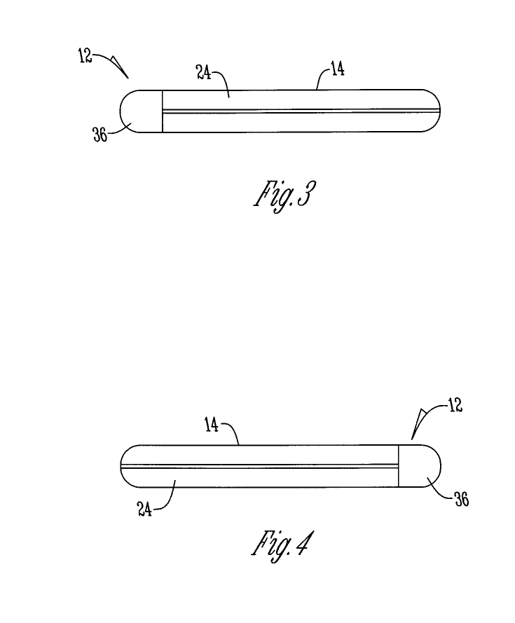

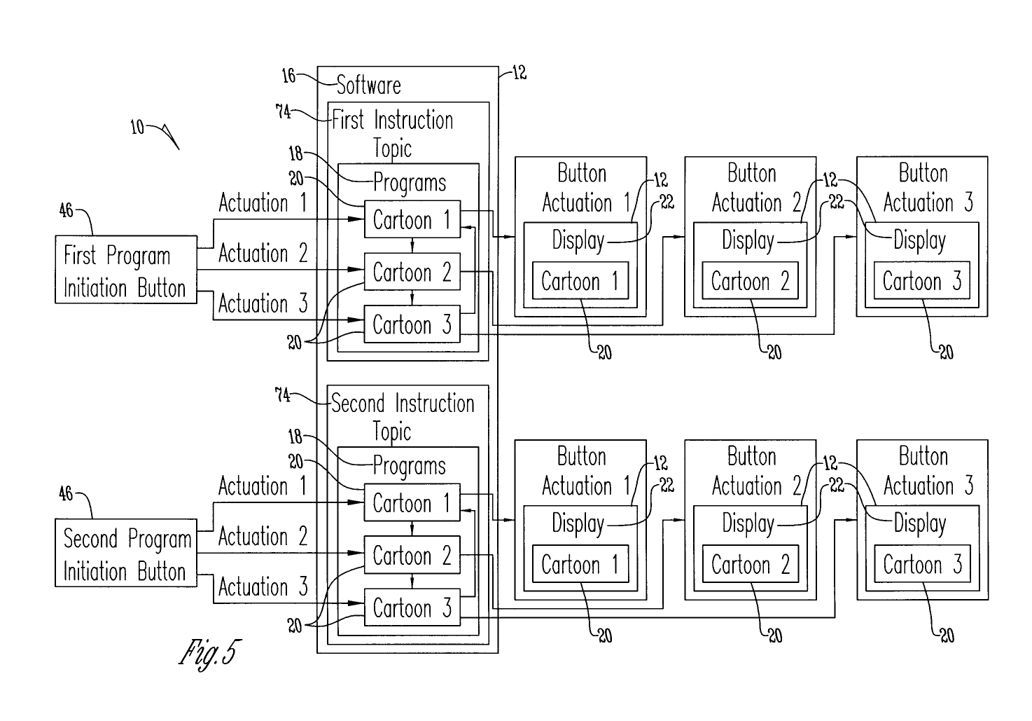

### DETAILED DESCRIPTION OF THE PREFERRED EMBODIMENT

Referring to the figures, an interactive system and method 10 for providing instruction includes an electronic device 12. In a preferred embodiment, the electronic device 12 is a hand-held, portable computer or gaming console 14 including a memory with software 16, RAM, and other data storage, display, retrieval and access components and capabilities such as USB ports or drives, CD drives, or other data drives or ports as is known in the art such that the device 12 is provided with the ability to store, access/retrieve, and display interactive programs 18. In a preferred embodiment the interactive programs 18 are cartoon-themed games 20 which provide instruction to children. The electronic device 12 includes additional features such as RAM, microprocessors, and the ability to connect to other computers, and/or an electronic network through any means presently known in the art to allow the device 12 to display interactive programs 18 or software 16 for children. Additionally, it is preferred that the electronic device 12 is compact and portable yet durable such that when dropped, jarred, shaken, or handled and used by young children, particularly between the ages of two and eight years of age, the device 12 is not easily broken. Alternatively, the electronic device 12 could be any computer or device which is capable of being actuated to perform the method for providing instruction 10 as disclosed herein.

A display or a screen portion 22 and a housing or casing 24 which houses the electronic circuitry, memory, drives, and electronic components as described above are included as part of the electronic device 12. The housing 24 includes an exterior 26 with a speaker 28 and a keypad or button portion 30 having a plurality of buttons or keys 32. In one embodiment, the display 22 and the housing 24 are attached by a hinge 34 which allows the display and screen portion 22 to be folded downward upon the housing 24 when not in use. The hinge 34 also includes connections 36 which allow the display 22 to be electronically connected, in communication with and actuated by the electronics within the casing 24 and the buttons 32. Alternatively, the electronic device 12 includes a touch-screen display which incorporates both a display portion 22 and tactile and/or pressure sensitive button icons 58 on a single touch screen. In yet another embodiment, the display 22 is provided as a component and mounted within the housing 24, thus incorporating the display 22 and housing 24 within a common casing with the keypad 30 and buttons 32 adjacent thereto.

The buttons 32 include a play button 38, volume control buttons 40, an on/off button or switch 42, and at least one program initiation button 46. In a preferred embodiment, the buttons 32 of the electronic device 12 are large, and the number and/or complexity of the buttons 32 incorporated in the housing 24 is minimized such that young children between the ages of two and eight years of age are able to easily operate the electronic device 12 without being overwhelmed. However, additional buttons 32 could also be incorporated including but not limited to a fast-forward button 48, a fast-rewind button 50, a stop button 52, a pause button 54 and forward and reverse buttons 56 which advance to a next and previous, respectively, song, track, title, or chapter in a song, movie, cartoon, show, or any other media program 18 played by the electronic device 12.

In a preferred embodiment, the program initiation buttons 46 are formed as icons and/or include graphics 58 printed thereon which correspond to and/or characterize the subject matter of the program 18 which is played once the buttons 32 are actuated. For example, the program initiation button 46 that initiates a program 18 or cartoon 20 which teaches how to properly brush teeth includes a tooth icon 60, and similarly, a button 46 that initiates a cartoon 20 which provides instruction as to how to properly wash hands includes an icon showing hands, a bar of soap, and/or suds 62. Furthermore, in one embodiment each of the plurality of buttons 32 includes indicia 68 associated with and printed on the casing 24 adjacent to each button 32, wherein the indicia 68 associated with each adjacent button 32 describes the function of the button 32, the operation that each button 32 performs, or provides a description of the program 18 that will be played when the buttons 46 are depressed or actuated.

The electronic device 12 is additionally provided with software 16, memory, programming and the like which both allows a program 18 to be played and controlled via actuation of the buttons 32 on the electronic device 12. Actuation of each of the plurality of program initiation buttons 46 accesses and initiates one of a plurality of programs 18, which in a preferred embodiment are cartoons 20, assigned to each program initiation button 46. Once a program initiation button 46 has been actuated or pressed by the user to access and display one of the educational media programs 18, the additional buttons 32 such as the play button 38, volume control buttons 40, stop button 52, pause button 54, fast-forward button 48, fast-rewind button 50, and forward and reverse buttons 56 are actuated initiate and control the presentation of the educational media program 18 on the display 22 of the device 12.

In operation, the user, which in a preferred embodiment is a child between the ages of two and eight, or the parent, teacher, or supervisor of a child between the ages of two and eight accesses the interactive system and method for providing instruction 10 by being provided with the electronic device 12. Specifically, it is preferred that the user is provided with the electronic device 12 at the appropriate time and place that the user is learning to perform the activity such that the user accesses and is exposed to the interactive system and method for providing instruction 10 while the user is performing the activity. For example, the user is provided with the device 12 and accesses the program 18 in the bathroom or at a sink while so the user can follow the steps provided on the display 22 while brushing their teeth or washing their hands. The user begins by first turning the electronic device 12 on via the on/off button 42, or alternatively, the electronic device 12 turns on automatically upon opening of the display screen 22. Once the device 12 is turned on, a menu screen 70 is provided with a scene having icons or graphics 72 which correspond to the subject matter of each of the different program initiation buttons 46 to allow the user to visually associate the particular program initiation or selection button 46 with the topic or category of instruction 74 of the program 18 which the button 46 provides.

In an exemplary embodiment, an electronic device 12 is provided with software 16 relating to personal hygiene activities performed in a bathroom and program initiation buttons 46 which initiate and display programs 18 for providing instruction on activities. These activities include but are not limited to tooth brushing, hand washing, and additional activities such as potty training and bathing. The software 16 presents a menu screen 70 depicting a scene of a bathroom 76 on the display 22 with a graphic or icon 72 of a sink 78 which corresponds to the hand washing program initiation button 46/62, a medicine cabinet 80 which corresponds to the tooth brushing program initiation button 46/60, and additionally a toilet 82 and a bath tub 84 which correspond to the potty training and bathing program initiation buttons, 46/64, 46/66 respectively. However, the electronic device 12 can additionally be provided with software 16, memory and associated program initiation buttons 46 relating to a variety of instructional topics 74 performed or associated with various different locations without departing from the spirit or scope of the invention.

From the menu screen 70, the user actuates or depresses one of the plurality of program initiation buttons 46. Each program initiation button 46 is associated with a different educational instruction topic or category 74 and a plurality of programs 18 are assigned to each program initiation button 46. Each of the plurality of programs 18 provides instruction on the particular topic 74 to which it is assigned and categorized. The user depresses the particular program selection button 46 corresponding to the particular activity that the user desires to perform, or alternatively, the topic 74 for which the user desires to receive instruction. Once the program initiation button 46 is actuated, the software 16 accesses and displays one of the plurality or set of programs 18 categorized within the associated instruction topic 74 assigned to each program selection button 46 stored within the memory of the electronic device 12, or alternatively, stored on a drive associated with the electronic device 12. Thus a different one of the plurality or set of programs 18 assigned to each program initiation button 46 is stored within and provide instruction on each corresponding instructional topic 74 played on the display 22 each successive time that particular program initiation button 46 is pressed or actuated.

In a preferred embodiment, each instruction topic 74 relates to personal hygiene, and a first program initiation button 46 accesses, initiates, and displays one of a plurality of programs 18 stored within the software 16 or memory of the electronic device 12 on the display 22 such that the displayed program 18 provides instructions on a first educational instruction topic 74 such as hand washing. Similarly, a second program initiation button 46 initiates one of a plurality of programs 18 stored within the software 16 or memory of the electronic device 12 on the display 22 providing instructions on a second educational instruction topic 74 such as tooth brushing. Furthermore, additional program initiation buttons 46 could also be provided to provide instructions on additional topics 74 of personal hygiene, including but not limited to potty training, face washing, and the like.

Each of the plurality of programs 18 assigned to each educational instruction topic 74 and stored within the electronic device 12 are educational media programs providing video and associated sounds which incorporate, embody, and provide instructions on each instruction topic 74. These are displayed as videos or played as games 20 on the display 22 upon the user's actuation of the associated program initiation button 46. In a preferred embodiment, each educational media program 18 is a cartoon-themed game 20 which provides children with instruction on proper personal hygiene and a set of two or more cartoon themed game 20 programs 18 are provided for each instruction topic 74 and assigned to each program initiation button 46 such that a different cartoon-themed game 20 providing instruction on a particular instruction personal hygiene topic 74 is accessed and provided on the display 22 each successive time the program initiation button 46 is pressed or actuated.

In a preferred embodiment, a first set of first, second, and third educational media programs 18 each display a first, second and third cartoon or cartoon themed game 20. Each of which provides instruction and teaching on a first instructional topic 74 such as hand washing such that the first, second, and third cartoons 20 rotate and a different one of the first, second and third cartoons 20 is displayed on the display 22 each successive time a first, or hand washing program initiation button 46/62 is pressed. Similarly, a second set of first, second, and third educational media programs 18 each display a first, second and third cartoon 20. This incorporates instruction and teaching on a second instructional topic 74 such as tooth brushing such that the first, second, and third cartoons 20 rotate and a different one of the second set of first, second and third cartoons 20 is displayed on the display 22 in response to sets of first, second, and third actuations of the second, or hand washing program initiation button 46/60.

Once a program initiation button 46 has been actuated or pressed by the user, the software 16 accesses one of the associated program files as provided above and displays one of the educational media cartoon themed games 20 or programs on the electronic device's display 22. Next, the cartoon themed game 20 is accessed and provided on the display 22. The user then initiates the cartoon themed game 20 program 18 by actuating or pressing the play button 38. The user navigates through the cartoon themed game 20 and receives step-by-step instruction on personal hygiene by viewing the program 18 once the play button 38 has been pressed. Alternatively, the user progresses through the steps provided on the program 18 by actuating the additional buttons 32 such as the fast-forward button 48, fast-rewind button 50, and forward and reverse buttons 56, or alternatively, gameplay buttons 32 provided on the device 12 such as “A”, “B”, “C” and “D” or “X”, “Y” and “Z” buttons 32. With the cartoon themed game 20 program 18 initiated, the user engages in the activity such as tooth brushing or hand washing while following the steps provided by the program 18. Furthermore, once the program 18 has been initiated, additional buttons 32 such as the volume control buttons 40, stop button 52, and pause button 54 can be actuated by the user to further control the presentation of the educational media program 18 or cartoon themed game 20 program 18 on the display 22 of the device 12.

Therefore, presented is an interactive system and method 10 has been disclosed which teaches children proper hygiene in a new and fun way. The system and method 10 provides instruction on personal hygiene as a game 20 on an electronic device 12 that children can play while engaging in and performing hygienic activities. The system and method 10 can also teach children the proper steps of brushing their teeth and washing their hands depending what button 46 on the device is pressed and as a series of three cartoons 20 for each button 46. Specifically, a different cartoon 20 will play each time a button 46 is pressed and as a result, at the very least, the interactive system and method 10 meets all of its stated objectives.

It will be appreciated by those skilled in the art that other various modifications could be made to the device without parting from the spirit and scope of this invention. All such modifications and changes fall within the scope of the claims and are intended to be covered thereby.

What is claimed is:

1. An interactive device for providing instruction, comprising:
an electronic device having a display screen and a plurality of keys wherein the plurality of keys include one or more program initiation buttons;
a plurality of interactive educational programs assigned to each of the one or more program initiation buttons wherein actuation of one of the one or more program initiation buttons initiates and displays one of the plurality of interactive educational programs assigned to the actuated program initiation button on the display screen of the device.

2. The interactive device of claim 1 wherein the electronic device includes a housing having a speaker.

3. The interactive device of claim 2 wherein the housing and display screen are attached by a hinge such that the display screen is folded downward upon the housing when the device is not in use.

4. The device of claim 1 wherein each of the one or more program initiation buttons is associated with a different educational instruction topic such that actuation of one of the one or more program initiation buttons initiates and displays one of a plurality of interactive educational programs categorized within an educational instruction topic assigned to the actuated program initiation button.

5. The device of claim 4 wherein a different one of the plurality of interactive educational programs categorized within an educational instruction topic and assigned to one of the one or more program initiation buttons is displayed on the display screen each successive time the assigned program initiation button is actuated.

6. The device of claim 5 wherein each of the one or more program initiation buttons include an icon which corresponds to the educational instruction topic assigned to each of the one or more program initiation buttons.

7. The device of claim 6 wherein each of the plurality of interactive educational programs is a different cartoon-themed game.

8. The device of claim 7 wherein each educational instruction topic is a different personal hygiene topic.

9. A method of providing instruction, comprising the steps of:
providing an electronic device having a display screen and a plurality of keys wherein the plurality of keys include one or more program initiation buttons;
providing a plurality of interactive educational programs assigned to each of the one or more program initiation buttons;
actuating one of the one or more program initiation buttons; and
initiating and displaying one of the plurality of interactive educational programs assigned to the actuated program initiation button on the display screen of the device.

10. The method of claim 9 wherein the electronic device includes a housing having a speaker.

11. The method of claim 10 further comprising the step of attaching the housing to the display screen by a hinge such that the display screen is folded downward upon the housing when the device is not in use.

12. The method of claim 9 further comprising the step of associating each of the one or more program initiation buttons with a different educational instruction topic such that actuation of one of the one or more program initiation buttons initiates and displays one of a plurality of interactive educational programs categorized within an educational instruction topic assigned to the actuated program initiation button.

13. The method of claim 12 further comprising the step of displaying a different one of the plurality of interactive educational programs categorized within an educational instruction topic and assigned to one of the one or more program initiation buttons on the display screen each successive time the assigned program initiation button is actuated.

14. The method of claim 13 wherein each of the one or more program initiation buttons include an icon which corresponds to the educational instruction topic assigned to each of the one or more program initiation buttons.

15. The method of claim 14 wherein each of the plurality of interactive educational programs is a different cartoon-themed game.

16. The method of claim 15 wherein each educational instruction topic is a different personal hygiene topic.
